(19) United States
(12) Patent Application Publication
(10) Pub. No.: US 2007/0140181 A1
(43) Pub. Date: Jun. 21, 2007

(54) SYSTEM AND METHOD FOR INTEGRATED CELLULAR ACCESS ROUTING

(75) Inventors: Radhakrishna Channegowda, Bangalore, Karnataka (IN); Paul Steinberg, Bartlett, IL (US); Manoj Wagle, Bangalore KRN (IN)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/275,259

(22) Filed: Dec. 21, 2005

(51) Int. Cl. H04Q 7/00; H04Q 7/24

(52) U.S. Cl. 370/338; 370/328

(57) ABSTRACT

A system (200) and method for integrated cellular access routing enables mobility across different cellular access networks. The system (200) includes a mobility router (300) and first and second media access controllers (310-1, 310-2) operatively connected to the mobility router (300). A first connectivity manager (325) is operatively connected to both the mobility router (300) and to the first and second media access controllers (310-1, 310-2). Thus a mobile station (105) can maintain a single Internet Protocol (IP) connectivity context when the mobile station (105) roams, from a connection to a first interface module controlled through the mobility router (300) by the first media access controller (310-1), to a connection to a second interface module controlled through the mobility router (300) by the second media access controller (310-2).

### FIELD OF THE INVENTION

The present invention relates generally to cellular access networks, and in particular to supporting mobility across different cellular access networks.

### BACKGROUND

Modem wireless communication networks are generally structured vertically, with a different network infrastructure required for each wireless access technology. For example, FIG. 1 is schematic diagram that illustrates the vertical structure of 2.5G and 3G cellular networks, as well as broadband wireless networks such as Wireless Fidelity (WiFi) and Worldwide interoperability for Microwave Access (WiMAX) networks, according to the prior art. As shown, although an operator can use a combination of cellular/wireless access technologies for providing IP connectivity and IP-based services, a separate infrastructure is deployed for each access technology. Thus an overall network 100, such as defined by the dashed line in FIG. 1, is extremely complex and expensive.

Further, the structural differences between the individual access networks in the overall network 100 require different protocols, procedures, and mechanisms for functions such as identification, addressing and AAA (Authentication, Authorizing, Accounting). For example, consider the significant structural differences between the following individual networks that are illustrated in FIG. 1:

A) A mobile station (MS) 105 participating in a third generation (3G) Universal Mobile Telecommunications System (UMTS) network, including High Speed Downlink/Uplink Packet Access (HSDPA/HSUPA) communicates wirelessly with a base station referred to as a Node B 110. The Node B 110 is in turn connected to a Radio Network Controller (RNC) 115, which is connected to a Serving GPRS Support Node (SGSN) 120. The SGSN 120 then connects to a Gateway GPRS Support Node (GGSN) 125, which finally connects to an IP network.

B) A MS 105 participating in a 3G Code Division Multiple Access (CDMA) network using EVolution Data Only (EVDO) technology communicates wirelessly with a Base Transceiver Station (BTS) 130. The BTS 130 is then connected to a Base Station Controller (BSC) 135. The BSC 125 is connected to a Packet Data Serving Node (PDSN) 140, which finally connects to an IP network.

C) A MS 105 participating in a Wireless Local Area Network (WLAN) communicates wirelessly with an Access Point (AP) 145. The AP 145 is then connected to a WLAN GateWay (WLAN/GW) 150, which finally connects to an IP network.

D) A MS 105 participating in a WiMAX network communicates with a WiMAX Base Transceiver Station (WiMAX BTS) 155. The WiMAX BTS 155 is then connected to a WiMAX Base Station Controller/GateWay (WiMAX BSC/GW) 160, which finally connects to an IP network.

Supporting seamless mobility of MSs 105 across different networks and different interfaces, such as those described above, is very challenging. Often numerous interworking gateways need to be deployed and numerous interworking policies need to be managed. Further, it can be very difficult to leverage common aspects of different networks and interfaces, resulting in duplication of numerous infrastructure functional elements. Thus in some cases seamless mobility across different networks and interfaces can be cost prohibitive.

### SUMMARY OF THE INVENTION

According to one aspect, the invention is a system for integrated cellular access routing. The system includes a mobility router and first and second media access controllers operatively connected to the mobility router. A first connectivity manager is operatively connected to both the mobility router and to the first and second media access controllers. Thus a mobile station can maintain a single Internet Protocol (IP) connectivity context when the mobile station roams, from a connection to a first interface module controlled through the mobility router by the first media access controller, to a connection to a second interface module controlled through the mobility router by the second media access controller.

According to another aspect, the invention is a method for integrated cellular access routing. The method includes receiving at a mobility router a first backhaul communication transmitted from a first interface module, and routing the first backhaul communication from the mobility router to a first media access controller operatively connected to a connectivity manager. Then a first Internet Protocol (IP) connectivity context associated with the first backhaul communication is identified at the connectivity manager. A second backhaul communication, transmitted from a second interface module, is then received at the mobility router and routed to a second media access controller operatively connected to the connectivity manager. The connectivity manager then identifies that the second backhaul communication is also associated with the first IP connectivity context. Thus the connectivity manager identifies that both the first and second backhaul communications are associated with a single Mobile Station (MS), and the MS is then able to roam from a connection to the first interface module to a connection to the second interface module.

Therefore, according to particular embodiments of the present invention, a common access network solution provides seamless IP connectivity to MSs using different air interfaces. For each MS, one IP connectivity context can be maintained, including information regarding, for example, IP addresses, authentication, and Quality of Service (QoS), which enables centralized management of AAA (Authentication, Authorization, and Accounting) and seamless mobility across multiple air interfaces.

### BRIEF DESCRIPTION OF THE DRAWINGS

In order that the invention may be readily understood and put into practical effect, reference will now be made to exemplary embodiments as illustrated with reference to the accompanying figures, wherein like reference numbers refer to identical or functionally similar elements throughout the separate views. The figures together with a detailed description below, are incorporated in and form part of the specification, and serve to further illustrate the embodiments and explain various principles and advantages, in accordance with the present invention, where:

FIG. 1 is a schematic diagram illustrating the vertical structure of 2.5G and 3G cellular networks, as well as broadband wireless networks, according to the prior art.

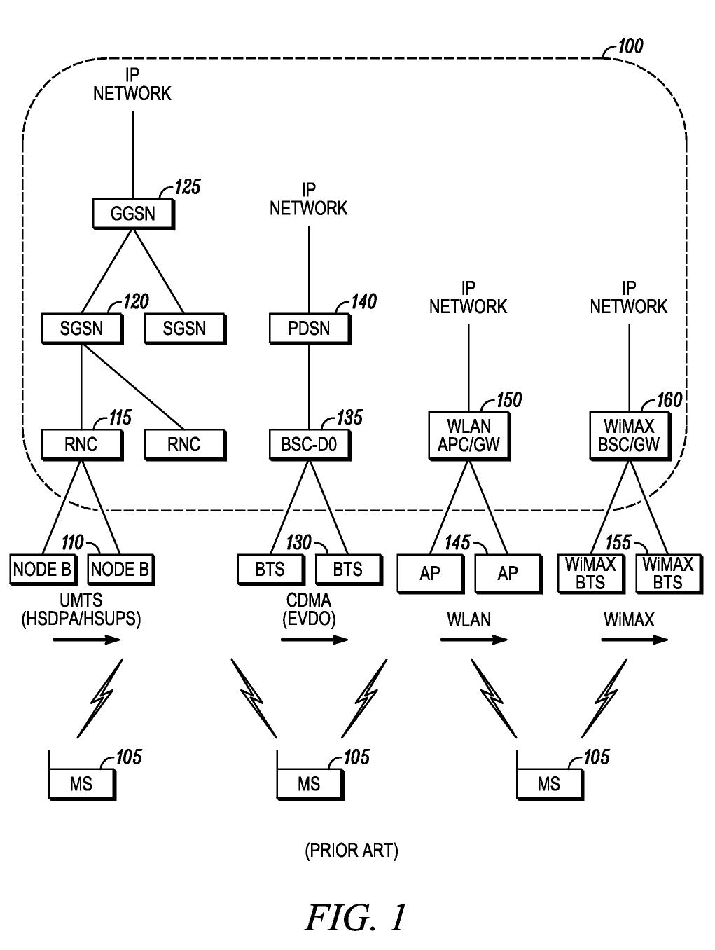

FIG. 2 is a schematic diagram illustrating functions of an integrated Cellular Access Router (iCAR) according to an embodiment of the present invention.

FIG. 3 is a schematic diagram illustrating the functional architecture and external interfaces of a Common Access Network (CAN) including an iCAR, according to an embodiment of the present invention.

FIG. 4 is a schematic diagram illustrating protocol stacks and interfaces managed by two iCARs, according to an embodiment of the present invention.

FIG. 5 is a schematic diagram illustrating an integrated network comprising two different types of common access networks, each including multiple iCARS, according to an embodiment of the present invention.

FIG. 6 is a general flow diagram illustrating a method for integrated cellular access routing according to an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a system and method for integrated cellular access routing. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

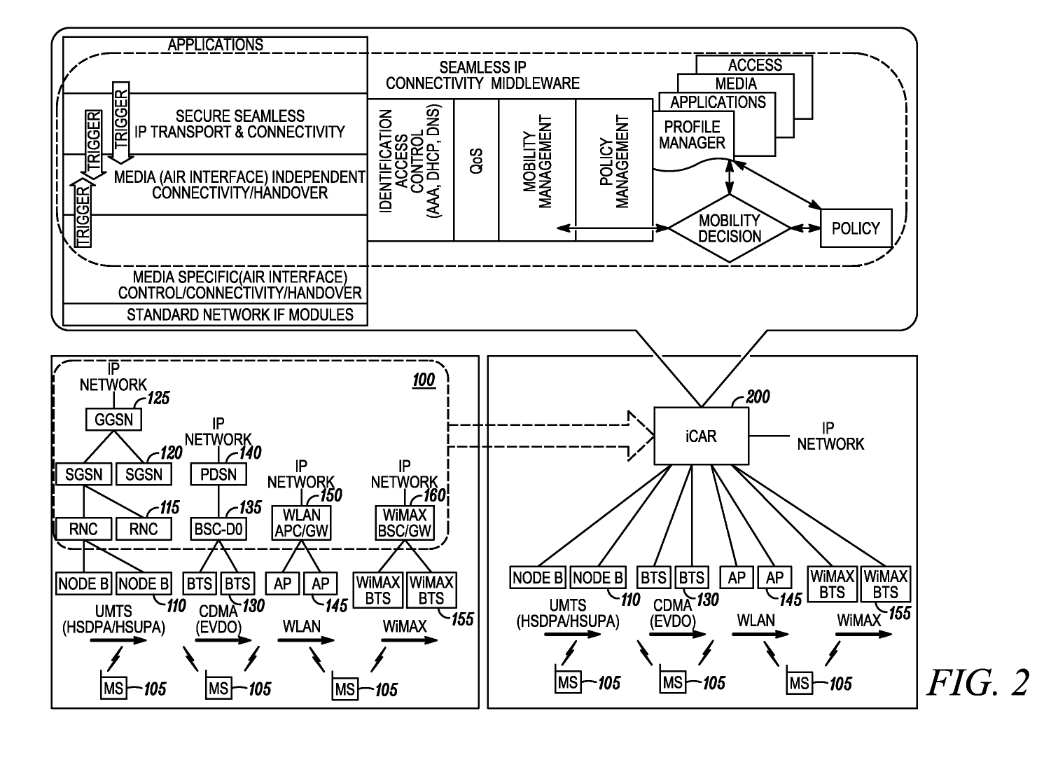

Referring to FIG. 2, a schematic diagram illustrates functions of an integrated Cellular Access Router (iCAR) 200 according to an embodiment of the present invention. An overall network 100 according to the prior art, including a plurality of separate vertical infrastructures, is shown replaced by a single iCAR 200.

The iCAR 200 provides media-specific (i.e., air interface specific) controller and mobility functions. The iCAR 200 also enables seamless IP connectivity and handovers for MSs 105 across a plurality of different access media or air interfaces. Seamless IP connectivity functions of the iCAR 200 include, for example, registration and identification of MSs 105, and management of: addressing, AAA, Quality of Service (QoS), security, mobility and policies that are all common for all air interfaces.

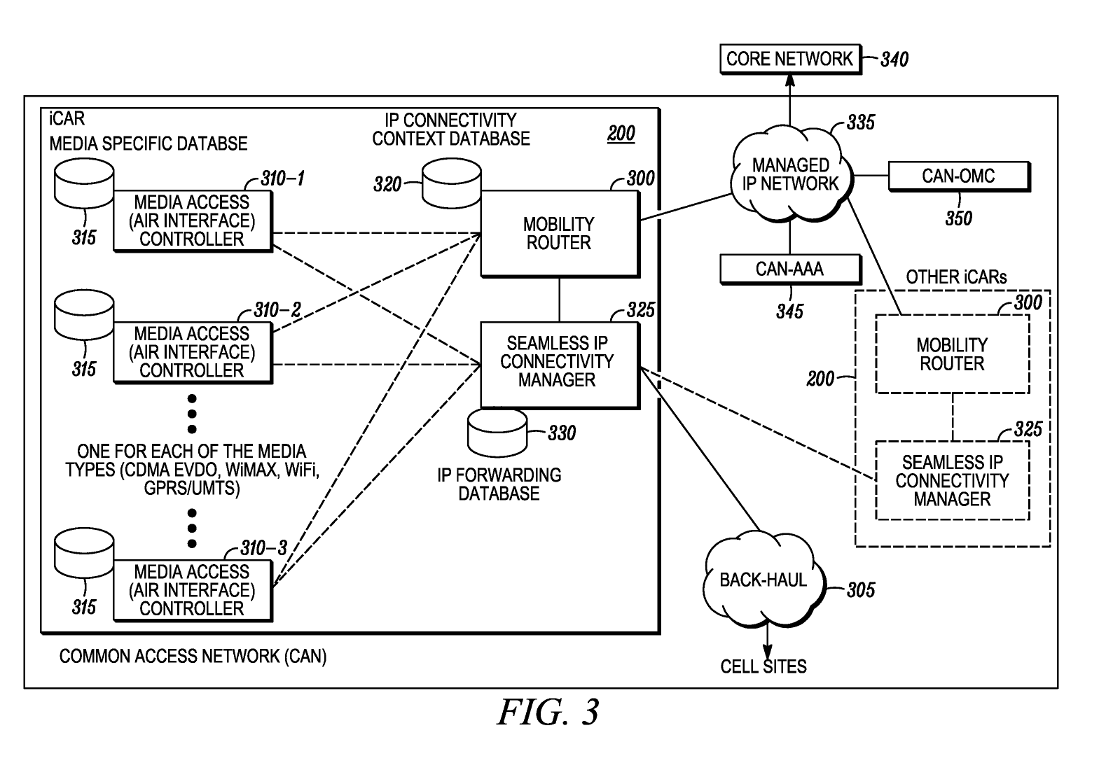

Referring to FIG. 3, a schematic diagram illustrates the functional architecture and external interfaces of a Common Access Network (CAN) including an iCAR 200, according to an embodiment of the present invention. A mobility router 300 is operatively connected to a plurality of backhaul interfaces 305 that connect with standard network interface modules such as a UMTS Node B 110, CDMA BTS 130, WLAN AP 145 and WiMAX BTS 155. The mobility router 300 provides mobility and routing functions for mobility architectures such as Mobile IP (MIP), MIP Regional Registration (MIP-RR), Hierarchical MIP (H-MIP), Cellular IP (CIP), Intra-Domain Mobility Management Protocol (IDMP), or Handoff Aware Wireless Access Internet Infrastructure (HAWAII). The mobility router 300 also supports standards-based mobility aware routing or transport networks and architectures, for standards defined for example by the Internet Engineering Task Force (IETF) or the Institute of Electrical and Electronic Engineers (IEEE).

The mobility router 300 is also operatively connected to a plurality of media access controllers 310-n. Each media access controller 310-n provides a medium-specific interface that communicates with a particular type of standard network interface module. For example, a media access controller 310-1 can communicate with UMTS Node Bs 110, a media access controller 310-2 can communicate with CDMA BTSs 130, and a media access controller 310-3 can communicate with WLAN APs 145. Each media access controller 310-n is operatively connected to a media specific database 315 for storing data concerning communications with a specific type of network interface module. Further, an IP connectivity database 320 is operatively connected to the mobility router 300, and stores data concerning, for example, routing different data types to different media access controllers 310-n.

In operation with the access controllers 310-n, the mobility router 300 also provides mobility aware routing and multicast functions. The mobility router 300 further performs IP paging and media-independent fast handovers between interface modules. Such media-independent fast handovers are enabled by a centralized connectivity manager 325 that maintains, in an IP forwarding database 330, all data concerning both a present interface module and a handover candidate interface module.

The connectivity manager 325 is operatively connected to the mobility router 300 and to each of the media access controllers 310-n. The connectivity manager 325 provides a single IP connectivity context for each MS 105 that is operatively connected to the iCAR 200. The single IP connectivity context comprises information that enables a MS 105 to roam from one standard network interface module to another. For example, a single IP connectivity context enables a MS 105 to roam from a CDMA BTS 130 to a WLAN AP 145.

A single IP connectivity context can include one or more IP addresses. Thus a MS 105 can use any of a plurality of IP addresses allocated to it, over multiple interface modules, during a single communication session. The multiple IP addresses are then transparent to any particular interface module.

Further, according to an embodiment of the present invention, a single IP connectivity context can be associated with all the information necessary to enable a MS 105 to perform a single sign-on process (e.g., including authentication and authorization) that enables seamless mobility across different interface modules. The information associated with an IP connectivity context can include for example interface identifications, identities, IP addresses, authentication data, QoS data, and policies.

An IP forwarding database 330 is operatively connected to the connectivity manager 325 and stores information concerning, for example, protocol support across multiple interface modules. The various protocols managed by the connectivity manager can include for example Point to Point Protocol (PPP), Packet Data Convergence Protocol (PDCP), and RObust Header Compression (ROHC).

The iCAR 200 according to the present embodiment is connected to a managed IP network 335 through the mobility router 300. The managed IP network 335 is then connected to a core network 340 and to other entities such as a Common Access Network for managing AAA (CAN-AAA) 345 and a CAN providing an Operation and Maintenance Center (CAN-OMC) 350. The iCAR 200 also can be connected to other iCARS 200, either through a managed IP network 340 or using a direct connection between connectivity managers 325.

According to yet another embodiment of the present invention, a MS 105 that is operatively connected to an iCAR 200 can access multiple interface modules simultaneously using multiple IP addresses. For example, a voice session can proceed using WiMAX, and a simultaneous file transfer session can proceed using WiFi. Thus both sessions continue to use the same IP connectivity context independently of an interface module.

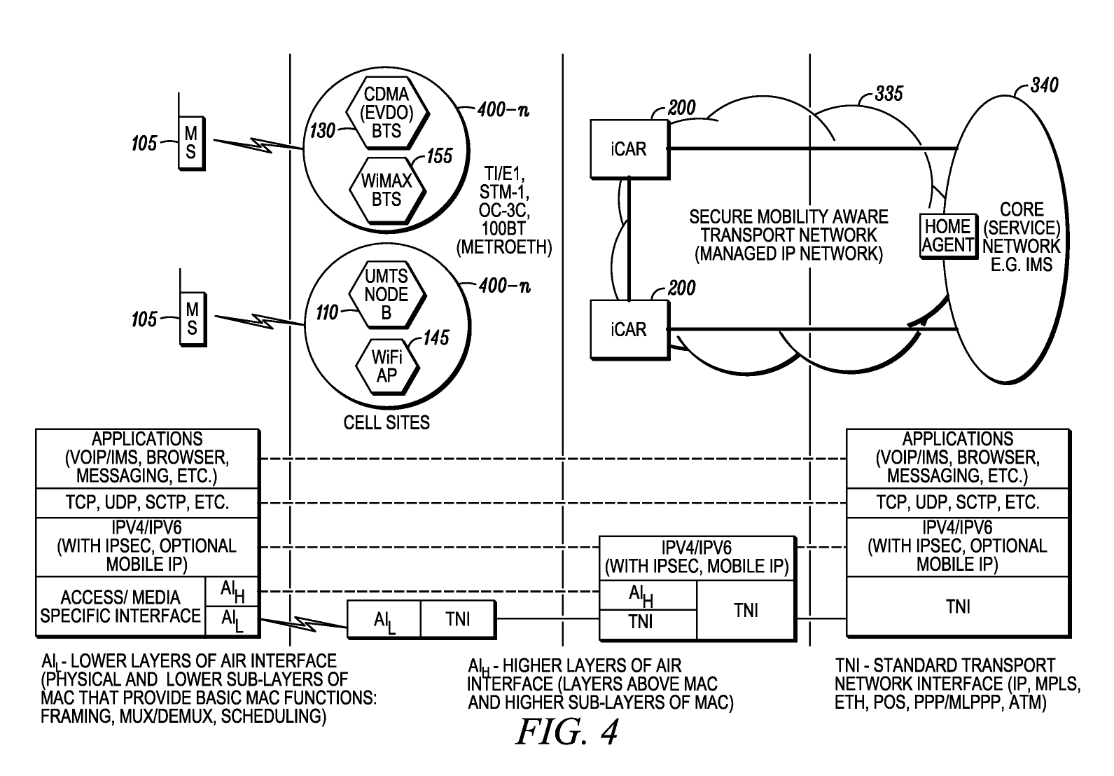

Referring to FIG. 4, a schematic diagram illustrates protocol stacks and interfaces managed by two iCARs 200, according to an embodiment of the present invention. IP connectivity managed by an iCAR 200 is under a single administrative domain for multiple air interfaces, and mobility management is primarily based on standard IP mobility architectures and mechanisms. Thus a cell site 400-n can comprise heterogeneous base stations 130 and access points 145, for example, which all share a single backhaul to an iCAR 200.

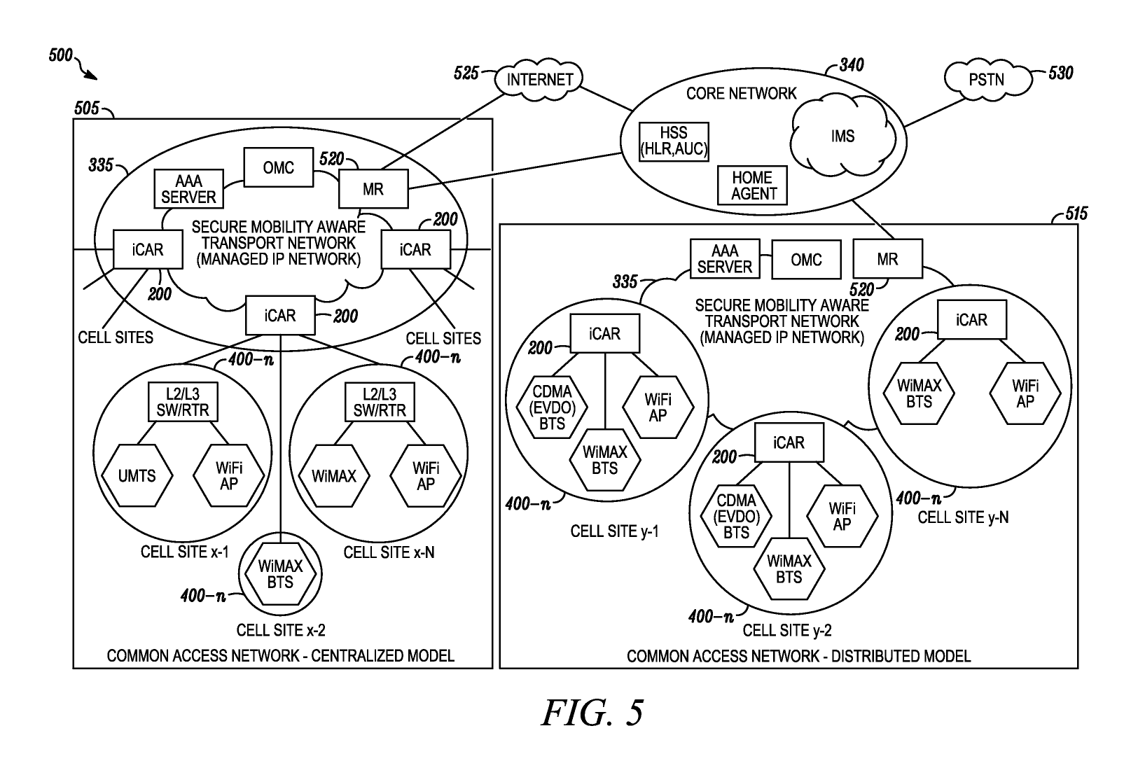

Referring to FIG. 5, a schematic diagram illustrates an integrated network 500 comprising two different types of common access networks, each including multiple iCARS 200, according to an embodiment of the present invention. A centralized model network 505 comprises a plurality of iCARs 200 connected through a secure mobility aware transport network such as a managed IP network 335. Each iCAR 200 in the managed IP network 335 then manages a plurality of cell sites 400-n. Alternatively, a distributed model network 515 comprises a plurality of iCARs 200 operating outside of a managed IP network 335, where each iCAR 200 manages a particular cell site 400-n. In both the centralized network 505 and the distributed network 515, an external mobility router 520 acts as a mobility anchor point for mobility across iCARs 200. The external mobility routers 520 then connect to a core network 340. The core network 340 is then connected to other networks such as the Internet 525 or a Public Switched Telephone Network (PSTN) 530.

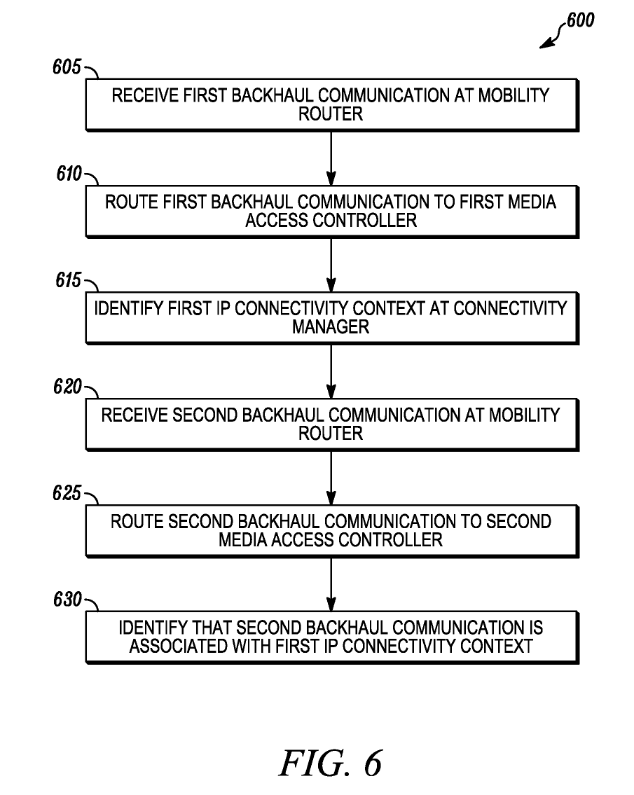

Referring to FIG. 6, a general flow diagram illustrates a method 600 for integrated cellular access routing according to an embodiment of the present invention. At step 605 a first backhaul communication transmitted from a first interface module is received at a mobility router 300. For example, a first communication from a MS 105 is transmitted through a WLAN AP 145 to the mobility router 300. At step 610 the first backhaul communication is routed from the mobility router 300 to a first media access controller 310-1 operatively connected to a connectivity manager 325. Then at step 615 a first IP connectivity context associated with the first backhaul communication is identified at the connectivity manager 325. For example the first media access controller 310-1 provides data to the connectivity manager 325 enabling the connectivity manager 325 to identify the IP connectivity context associated with the first backhaul communication. At step 620 a second backhaul communication transmitted from a second interface module is received at the mobility router 300. For example, a second communication from the same MS 105 that transmitted the first communication, which first communication was received at step 605, is transmitted through a CDMA BTS 130 to the mobility router 300. At step 625 the second backhaul communication is routed to a second media access controller 310-2 that is also operatively connected to the connectivity manager 325. Then, at step 630, the connectivity manager 325 identifies that the second backhaul communication is also associated with the first IP connectivity context. Thus the connectivity manager 325 identifies that both the first and second backhaul communications are associated with the same MS 105, and the MS 105 is then able to roam from a connection to the first interface module to a connection to the second interface module.

Advantages of embodiments of the present invention therefore include a common access network solution that provides seamless IP connectivity to MSs 105 using different air interfaces. An iCAR 200, according to an embodiment of the present invention, thus supports scalable and flexible network models—both centralized and distributed—and avoids complex inter-working gateway infrastructures.

It will be appreciated that embodiments of the invention described herein may be comprised of one or more conventional processors and unique stored program instructions that control the one or more processors to implement, in conjunction with certain non-processor circuits, some, most, or all of the functions of integrated cellular access routing as described herein. The non-processor circuits may include, but are not limited to, a radio receiver, a radio transmitter, signal drivers, clock circuits, power source circuits, and user input devices. As such, these functions may be interpreted as steps of a method for integrated cellular access routing. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any elements that may cause any benefit, advantage, or solution to occur or become more pronounced are not to be construed as critical, required, or essential features or elements of any or all of the claims. The invention is defined solely by the appended claims including any amendments made during the pendency of this application and all equivalents of those claims.

We claim:

1. A system for integrated cellular access routing, comprising:
a mobility router;
first and second media access controllers operatively connected to the mobility router; and
a first connectivity manager operatively connected to both the mobility router and to the first and second media access controllers, whereby a mobile station maintains a single Internet Protocol (IP) connectivity context when the mobile station roams from a connection to a first interface module controlled through the mobility router by the first media access controller to a connection to a second interface module controlled through the mobility router by the second media access controller.

2. The system of claim 1, further comprising additional media access controllers.

3. The system of claim 1, wherein the first and second interface modules are standard network interface modules selected from the group consisting of: Universal Mobile Telecommunications System (UMTS) network base stations; Code Division Multiple Access (CDMA) network Base Transceiver Stations (BTSs); Wireless Local Area Network (WLAN) Access Points (APs); and Worldwide interoperability for Microwave Access (WiMAX) BTSs.

4. The system of claim 1, wherein each of the first and second media access controllers interface with a media type selected from the group consisting of CDMA, WiMAX, WiFi, and GPRS/UMTS.

5. The system of claim 1, wherein the connectivity manager provides for both the first and second media access controllers a single IP infrastructure managing authentication, authorization, and accounting (AAA), identification, security, and Quality of Service (QoS) of backhaul communications with the interface modules.

6. The system of claim 1, wherein the mobility router provides IP-based mobility management for mobility architectures comprising: Mobile IP (MIP), MIP Regional Registration (MIP-RR), Hierarchical MIP (H-MIP, Cellular IP (CIP), Intra-Domain Mobility Management Protocol (IDMP), or Handoff Aware Wireless Access Internet Infrastructure (HAWAII).

7. The system of claim 1, wherein the mobility router is operatively connected to a managed IP network.

8. The system of claim 1, wherein the first connectivity manager is operatively connected to a second connectivity manager associated with another system for integrated cellular access routing.

9. The system of claim 1, wherein the first and second interface modules are in different cell sites.

10. The system of claim 1, wherein the first and second interface modules are in the same cell site.

11. A method for integrated cellular access routing, comprising:
receiving at a mobility router a first backhaul communication transmitted from a first interface module;
routing the first backhaul communication from the mobility router to a first media access controller operatively connected to a connectivity manager;
identifying at the connectivity manager a first Internet Protocol (IP) connectivity context associated with the first backhaul communication;
receiving at the mobility router a second backhaul communication transmitted from a second interface module;
routing the second backhaul communication to a second media access controller operatively connected to the connectivity manager; and
identifying at the connectivity manager that the second backhaul communication is associated with the first IP connectivity context, whereby a mobile station maintains the same first IP connectivity context when it roams from a connection to the first interface module to a connection to the second interface module.

12. The method of claim 11, wherein each of the first and second media access controllers interface with a media type selected from the group consisting of CDMA, WiMAX, WiFi, and GPRS/UMTS.

13. The method of claim 11, wherein the first and second interface modules are standard network interface modules selected from the group consisting of: Universal Mobile Telecommunications System (UMTS) network base stations; Code Division Multiple Access (CDMA) network Base Transceiver Stations (BTSs); Wireless Local Area Network (WLAN) Access Points (APs); and Worldwide interoperability for Microwave Access (WiMAX) BTSs.

14. The method of claim 11, wherein the connectivity manager provides for both the first and second media access controllers a single IP infrastructure managing authentication, authorization, and accounting (AAA), identification, security, and Quality of Service (QoS) of backhaul communications.

15. The method of claim 11, wherein the connectivity manager provides an IP infrastructure to the first and second media access controllers for managing first and second simultaneous communications with a single Mobile Station (MS), where the first simultaneous communication is transmitted through the first interface module and the second simultaneous communication is transmitted through the second interface module.

16. The method of claim 11, wherein the mobility router provides IP-based mobility management for mobility architectures comprising: Mobile IP (MIP), MIP Regional Regisration (MIP-RR), Hierarchical MIP (H-MIP, Celular IP (CIP), Intra-Domain Mobility Management Protocol (IDMP), or Handoff Aware Wireless Access Internet Infrastructure (HAWAII).

17. The method of claim 11, wherein the first and second interface modules are in different cell sites.

18. The method of claim 11, wherein the first and second interface modules are in the same cell site.

19. A system for integrated cellular access routing, comprising:
means for receiving at a mobility router a first backhaul communication transmitted from a first interface module;
means for routing the first backhaul communication to a first media access controller operatively connected to a connectivity manager;
means for identifying at the connectivity manager a first Internet Protocol (IP) connectivity context associated with the first backhaul communication;
means for receiving at the mobility router a second backhaul communication transmitted from a second interface module;
means for routing the second backhaul communication to a second media access controller operatively connected to the connectivity manager; and
means for identifying at the connectivity manager that the second backhaul communication is associated with the first IP connectivity context, whereby a mobile station maintains the same first IP connectivity context when it roams from the first to the second interface module.
